(19) United States
(12) Patent Application Publication
(10) Pub. No.: US 2009/0106024 A1
(43) Pub. Date: Apr. 23, 2009

(54) PORTABLE ELECTRONIC DEVICE AND A NOISE SUPPRESSING METHOD THEREOF

(75) Inventor: MENG-CHUN CHEN, Tu-Cheng (TW)

Correspondence Address: PCE INDUSTRY, INC.;ATT. Steven Reiss, 458 E. LAMBERT ROAD, FULLERTON, CA, 92835, US

(73) Assignee: Chi Mei Communication Systems, Inc., Tu-Cheng City (TW)

(21) Appl. No.: 11/967,039

(22) Filed: Dec. 29, 2007

(30) Foreign Application Priority Data
Oct. 19, 2007 (CN) 200710202164.2

(51) Int. Cl. G10L 17/00

(52) U.S. Cl. 704/246; 704/231

(57) ABSTRACT

A portable electronic device comprises a main body (10), and a voice-receiving device, a voice output device and a voice input device that are respectively configured in the main body. The voice-receiving device includes a signal-receiving unit (182) for receiving voice signal from a communication network of the portable electronic device and a noise-detecting unit (184) configured for detecting if a noise exists around the voice receiving device. The voice output device is electronically connected with the voice receiving device and configured for generating an audio signal to counteract the noise around the voice receiving device according to the information of the noise received from the noise-detecting unit. The voice input device is electronically connected with the voice receiving device and the voice output device. A noise-suppressing method of the portable electronic device is also disclosed.

### BACKGROUND OF THE INVENTION

1. Field of the Invention

The present invention generally relates to portable electronic devices, particularly to a portable electronic device and a noise suppressing method thereof.

2. Discussion of the Related Art

With the development of wireless communication and information processing technologies, portable electronic devices, such as mobile phones and personal digital assistants (PDAs), are now in widespread use.

When using a mobile phone in a noisy environment, the communication of the call may be influence by the surrounding noises. An anti-noise earphone has been used to overcome this problem. However, different mobile phones may have different earphone interface standards. As a result, the user needs to purchase an additional anti-noise earphone for his/her mobile phone.

Therefore, a portable electronic device, such as a mobile phone, with a noise suppressing function and a noise suppressing method thereof are desired in order to overcome the above-described problems.

### SUMMARY

In one aspect thereof, a portable electronic device comprises a main body, and a voice-receiving device, a voice output device and a voice input device that are respectively installed in the main body. The voice-receiving device includes a signal-receiving unit for receiving voice signal from a communication network of the portable electronic device and a noise-detecting unit configured for detecting if a noise exists around the voice receiving device. The voice output device is electronically connected with the voice receiving device and configured for generating an audio signal to counteract the noise around the voice receiving device according to the information of the noise received from the noise-detecting unit. The voice input device is electronically connected with the voice receiving device and the voice output device.

In another embodiment thereof, a noise-suppressing method comprises the following steps. Providing a portable electronic device including a voice receiving device, a voice output device and a voice input device, the voice receiving device includes a signal receiving unit and a noise-detecting device with a noise-detecting process, the voice output device includes an audio signal generator. The signal receiving unit receives a voice signal from a communication network of the portable electronic device. The noise-detecting unit detects if a noise exists around the voice receiving device. If a noise exists around the voice receiving device, the noise-detecting unit measures an amplitude and a phrase of the noise, and sends the measured result of amplitude and phrase of the noise to the audio signal generator. The audio signal generator generates an audio signal to counteract the noise around the voice receiving device, the phrase of the audio signal is contrary to the phrase of the noise, and the amplitude of the audio signal is same with the amplitude of the noise.

Other advantages and novel features of the embodiments will become more apparent from the following detailed description thereof when taken in conjunction with the accompanying drawings.

### BRIEF DESCRIPTION OF THE DRAWINGS

Many aspects of the portable electronic device and a noise suppressing method thereof can be better understood with reference to the following drawings. Drawings are not necessarily drawn to scale, the emphasis instead being placed upon clearly illustrating the principles of the present portable electronic device and a noise suppressing method thereof. Moreover, in the drawings, like reference numerals designate corresponding parts throughout the several views, in which:

FIG. 1 is an isometric view of a portable electronic device, in accordance with a present embodiment; and

FIG. 2 is a function block of the portable electronic device shown in FIG. 1.

### DETAILED DESCRIPTION OF THE EMBODIMENTS

The present portable electronic device and the noise suppressing method thereof is suitable for mobile phones, PDAs, and so on.

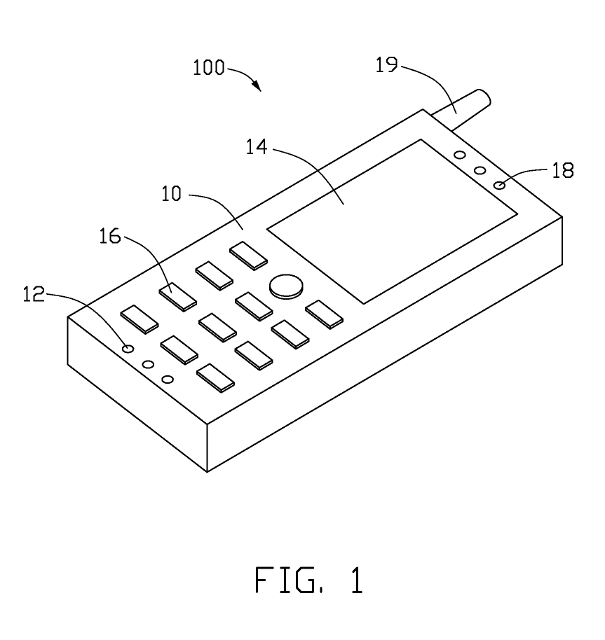

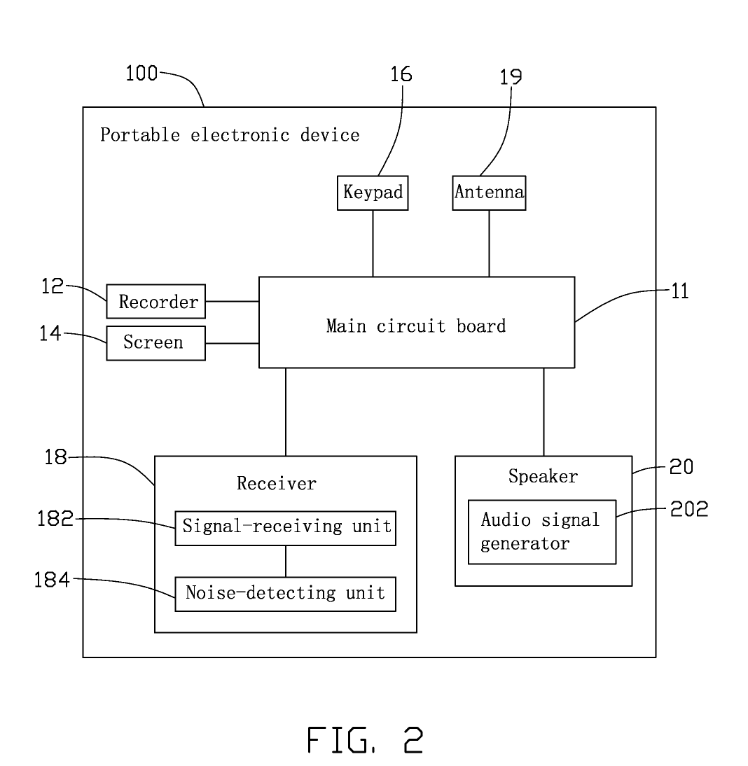

Referring to FIGS. 1 and 2, a portable electronic device 100 herein is a mobile phone. The portable electronic device 100 includes a main body 10, a main circuit board 11 and a plurality of functional modules including a recorder 12, a screen 14, a keypad 16, a receiver 18 and an antenna 19. The recorder 12, the screen 14, the keypad 16, the receiver 18 and the antenna 19 are configured in the main body 10. The recorder 12, the screen 14, the keypad 16, the receiver 18 and the antenna 19 are respectively electronically connected to the main circuit board 11, so that a data can be transmitted therebetween.

When in communication, the recorder 12 is a voice input device of the portable electronic device 100. A voice of a user is inputted to the portable electronic device 100 through the recorder 12, and sent to a person on the other side of the communication though the antenna 19. The recorder 12 can also function as a microphone. The screen 14 is a LCD (liquid crystal display) configured for displaying contents input by the keypad 16 and contents received/sent by the portable electronic device 100. The keypad 16 is configured for inputting information.

The receiver 18 is a voice receiving device of the portable electronic device 100. The receiver 18 includes a signal-receiving unit 182 and noise-detecting unit 184. The signal-receiving unit 182 is configured for receiving the voice signal from the person on the other side of the communication. The noise-detecting unit 184 detects if a noise exists around the receiver 18 of the portable electronic device 100, and measuring the amplitude and phrase of the noise, if a noise appears.

Referring to FIG. 2, the portable electronic device 100 further includes a speaker 20 configured in the main body 10 and used as a voice output device. The voice can be MP3 (MPEG Audio Layer 3) music ringtone, warning tone and conversation of a call, and so on. The speaker 20 includes an audio signal generator 202. If a noise exists around the portable electronic device 100, the noise-detecting unit 184 senses the noise, and then measures the amplitude and phrase of the noise, and sends the measured result of amplitude and phrase of the noise to the audio signal generator 202 of the speaker 20. The audio signal generator 202 generates an audio signal to counteract the noise. A phrase of the audio signal is contrary to the phrase of the noise, and the amplitude of the audio signal is same with the amplitude of the noise. If the noise-detecting unit 184 senses no noise exists around the portable electronic device 100, the audio signal generator 202 will not execute any action of the portable electronic device 100.

It is to be further understood that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device comprising:
a main body;
a voice-receiving device installed in the main body and including a signal-receiving unit for receiving voice signal from a communication network of the portable electronic device and a noise-detecting unit configured for detecting if a noise exists around the voice receiving device;
a voice output device installed in the main body and electronically connected with the voice receiving device, the voice output device configured for generating an audio signal to counteract the noise around the voice receiving device according to the information of the noise received from the noise-detecting unit; and
a voice input device installed in the main body and electronically connected with the voice receiving device and the voice output device.

2. The portable electronic device as claimed in claim 1, wherein the voice output device includes an audio signal generator, the audio signal generator generating an audio signal, the phrase of the audio signal is contrary to the phrase of the noise, and the amplitude of the audio signal is same with the amplitude of the noise.

3. The portable electronic device as claimed in claim 2, wherein the noise-detecting unit measures the amplitude and phrase of the noise, and sends the amplitude and phrase of the noise to the audio signal generator.

4. The portable electronic device as claimed in claim 2, wherein the audio signal generator executes no action if the noise-detecting unit senses no noise exists around the portable electronic device.

5. The portable electronic device as claimed in claim 1, wherein the voice input device is a recorder.

6. The portable electronic device as claimed in claim 1, wherein the voice receiving device is a receiver.

7. The portable electronic device as claimed in claim 1, wherein the voice output device is a speaker.

8. A noise-suppressing method, comprising:
providing a portable electronic device including a voice receiving device, a voice output device and a voice input device, the voice receiving device including a signal receiving unit and a noise-detecting device, the voice output device including an audio signal generator;
the signal receiving unit receiving a voice signal from a communication network of the portable electronic device;
the noise-detecting unit detecting if a noise exists around the voice receiving device;
if a noise exists around the voice receiving device, the noise-detecting unit measuring an amplitude and a phrase of the noise, and sending the measured result of amplitude and phrase of the noise to the audio signal generator;
the audio signal generator generating an audio signal to counteract the noise around the voice receiving device, the phrase of the audio signal is contrary to the phrase of the noise, and the amplitude of the audio signal is same with the amplitude of the noise.

9. The noise-suppressing method as claimed in claim 8, wherein the voice input device is a recorder.

10. The noise-suppressing method as claimed in claim 8, wherein the voice receiving device is a receiver.

11. The noise-suppressing method as claimed in claim 8, wherein the voice output device is a speaker.
